(19) United States
(12) Patent Application Publication
(10) Pub. No.: US 2016/0154964 A1
(43) Pub. Date: Jun. 2, 2016

(54) Method and System of Managing Digital Multimedia Content

(71) Applicant: SmartStory Technologies, Inc., Boise, ID (US)

(72) Inventors: Evanson G. Baiya, Meridian, ID (US); Jeffrey A. Bull, Boise, ID (US); Kenneth D. Holsinger, Eagle, ID (US); Michael A. Boerner, Boise, ID (US)

(21) Appl. No.: 15/019,030

(22) Filed: Feb. 9, 2016

Related U.S. Application Data
(63) Continuation of application No. 13/033,278, filed on Feb. 23, 2011, now abandoned.
(60) Provisional application No. 61/307,196, filed on Feb. 23, 2010.

(51) Int. Cl. G06F 21/60; G06F 17/30; G06Q 30/06; G06F 21/62

(52) U.S. Cl. CPC G06F 21/602; G06F 21/6218; G06F 17/30321; G06Q 30/0601

(57) ABSTRACT

Methods and systems of managing content. More particularly, methods and systems of managing digital media content are provided. A Content Manager Application (Content Manager) can provide one or more user interfaces (UI) allowing a content provider to manage, edit, tag, group, store, secure, and distribute content to a consumer of content.

### PRIORITY/CROSS-REFERENCE TO RELATED APPLICATIONS

This application claims the benefit of U.S. Provisional Application No. 61/307,196, filed Feb. 23, 2010.

### TECHNICAL FIELD

The disclosure generally relates to software, and more particularly to hardware/software used with digital media content and the like.

### BACKGROUND

A content provider can include, but is not limited to, a group, business, organization, or individual that provides digital media content to a user. “Digital media content” (“content”) means data available in digital form. An individual digital media content file is a “content item.” Examples of digital media content include, but are not limited to, documents, multimedia, text, code (e.g., JavaScript, HTML), audio, video, simulation files, photographs, XML, RSS feeds, data, and images.

A user can utilize any number of different computer systems to access digital media content. Examples of common “computer systems” include personal computers, televisions, digital cameras, smart phones, PDA's, and other hand-held devices.

In addition to the great number of different computer systems a user might use to access digital media content, each of those computer systems have differing needs when it comes to preferred digital media content file formats (e.g., Apple iPad® tablets cannot utilize content presented in Adobe Flash® format and as such a content provider must provide an “iPad friendly” version of their digital media content if they wish for all users to be able to access their digital content). As a result, a content provider will typically take an original digital media content file (master) and create a number of versions of content item (derivatives), each version having different characteristics. This enables users with computer systems to access the digital media content item. For instance, a content provider might take an original HD video and create a number of derivatives of the video, each derivative having different characteristics, such as different aspect ratios, encoding, and file size.

By having a plurality of copies (derivatives) of an original (master) digital media content item, a content provider can struggle with storing, organizing, accessing, providing access to, and managing the derivative copies.

### SUMMARY OF THE DISCLOSURE

Several exemplary methods and systems of managing digital multimedia content are described herein.

An exemplary system for the management of digital multimedia content comprises a computer-implemented digital multimedia content management system comprising the following computer executable components: an upload component that uploads digital media content; a queue component that temporarily stores the digital media content; a catalog component that allows a first user to tag the digital media content with one or more attributes; a storage component that stores the digital media content; a grouping component that groups the digital media content according to the one or more attributes; a licensing component that attaches one or more keys to the digital media content; a security component that encrypts the digital media content; and a sharing component that allows one or more second users to access the digital media content.

An exemplary method for the management of digital multimedia content comprises a computer-implemented method of managing digital multimedia content comprising the following computer-executable acts: uploading digital media content to a queue that temporarily stores the digital media content; tagging the digital media content with one or more attributes, the one or more attributes being attached to the digital media content as metadata; grouping the digital media content according to the metadata; storing the digital media content; attaching one or more keys to the digital media content; sharing the digital media content with one or more second users, where the digital media content is in a first format, and the digital media content is requested in a second format, the digital media content being converted to the second format prior to sharing the digital media content with the one or more second users.

Another exemplary method for the management of digital multimedia content comprises a computer-implemented method of managing digital multimedia content comprising the following computer-executable acts: uploading digital media content, the digital media content being assigned a unique ID, the unique ID tracking all modifications of the digital media content and the tagged attributes; tagging the digital media content with one or more attributes, the one or more attributes being attached to the digital media content as metadata; grouping the digital media content according to the metadata; storing the digital media content; attaching one or more keys to the digital media content, the one or more keys restricting access to the digital media content; encrypting the digital media content; and sharing the digital media content with one or more second users, where the digital media content is in a first format, and the digital media content is requested in a second format, the digital media content being converted to the second format prior to sharing the digital media content with the one or more second users, the second format relating to at least one of connectivity, requested format, and device type of the one or more second users, where the one or more second users provide information relating to the one or more keys prior to sharing the digital media content, where the digital media content is streamed to the one or more second users.

Additional understanding of the systems and methods contemplated and/or claimed by the inventors can be gained by reviewing the detailed description of exemplary systems and methods, presented below, and the referenced drawings.

### BRIEF DESCRIPTION OF THE DRAWINGS

FIG. 1 is a block diagram illustrating an exemplary computer system upon which an exemplary system for the management of digital multimedia content may be implemented.

FIG. 2 is a block diagram illustrating an exemplary method in which a first user could use a computer system to accesses an exemplary system for the management of digital multimedia content via a web browser.

FIG. 3 is a flowchart illustrating another first exemplary system for the management of digital multimedia content, illustrating a first exemplary content management interface.

FIG. 4 illustrates another exemplary method for the management of digital multimedia content.

FIG. 5 illustrates another exemplary method for the management of digital multimedia content.

### DETAILED DESCRIPTION

The following description and the referenced drawings provide illustrative examples of that which the inventors regard as their invention. As such, the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

The use of “e.g.,” “etc.,” “for instance,” “in example,” and “or” and grammatically related terms indicates non-exclusive alternatives without limitation, unless otherwise noted. The use of “including” and grammatically related terms means “including, but not limited to,” unless otherwise noted. The use of the articles “a,” “an” and “the” are meant to be interpreted as referring to the singular as well as the plural, unless the context clearly dictates otherwise. Thus, for example, reference to “a database” is intended to include “one or more” databases. The use of “exemplary” means “an example of” and is not intended to convey a meaning of an ideal or preferred embodiment.

Several exemplary methods and systems for the management of digital multimedia content (each a “Content Manager”) are described herein. The term “management” is used generally herein, and conceptually includes storage, management and distribution of multimedia content.

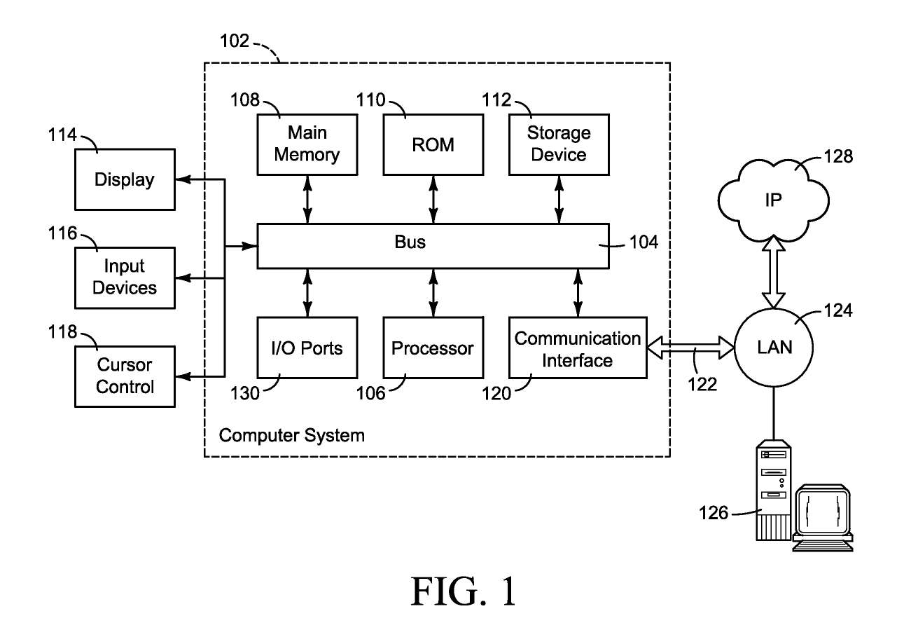

FIG. 1 illustrates a computer system 102 upon which an exemplary system for the management of digital multimedia content may be implemented.

As used herein, the term “computer system” means one or more general-purpose and/or specific-purpose computers, one or more digital information processing machines (devices, software, hardware, or the combination thereof, that processes digital information), or one or more digital clients (devices, software, hardware, or the combination thereof, that allows an individual to utilize digital media content). Thus, computer systems may include, but are not limited to, host computers, client computers, server computers, desktop computers, laptop computers, tablet computers, televisions, digital cameras, smart phones, cellular phones, hand-held devices, digital media devices, digital media players, peripherals, machines, telecommunications devices (e.g., modems and routers), composite systems composed from multiple other systems, embedded controller systems, microprocessor-based systems, digital signal processor-based systems, personal digital assistant (PDA) systems, Internet connected devices, digital hubs, gaming systems (e.g., Xbox 360®, Wii®), home theater components, wireless systems, wireless networking systems, digital picture frame with or without wireless capabilities, and computer software/software subsystems running therein.

For instance, a user may use a computer system 102 to access the Content Manager via a user interface.

The computer system 102 may include a bus 104 or other communication mechanism for communicating information and a processor 106 coupled with bus 104 for processing the information. The computer system 102 may also include a main memory 108, such as a random access memory (RAM) or other dynamic storage device (e.g., dynamic RAM (DRAM), static RAM (SRAM), synchronous DRAM (SDRAM), flash RAM), coupled to bus 104 for storing information and instructions to be executed by processor 106. In addition, main memory 108 may be used for storing temporary variables or other intermediate information during execution of instructions to be executed by processor 106.

The computer system 102 may further include a read only memory (ROM) 110 or other static storage device (e.g., programmable ROM (PROM), erasable PROM (EPROM), and electrically erasable PROM (EEPROM)) coupled to bus 104 for storing static information and instructions for processor 106. A storage device 112 (e.g., hard drive, floppy drive, magnetic disk, flash disk, optical disk) may be provided and coupled to bus 104 for storing information and instructions.

The computer system 102 may also include input/output ports 130 to couple the computer system 102 to external devices. Such coupling may include direct electrical connections, wireless connections, networked connections, etc., for implementing automatic control functions, remote control functions, etc.

The computer system 102 may also include special purpose logic devices (e.g., application specific integrated circuits (ASICs)) or configurable logic devices (e.g., generic array of logic (GAL), re-programmable field programmable gate arrays (FPGAs)). Other removable media devices (e.g., compact disc (CD), magnetic tape, removable magneto-optical media) or fixed, high-density media drives, may be added to the computer system 102 using an appropriate device bus (e.g., small computer system interface (SCSI) bus, enhanced integrated device electronics (EIDE) bus, ultra-direct memory access (DMA) bus). The computer system 102 may additionally include a peripheral (e.g., compact disc reader, DVD reader, compact disc reader-writer unit, DVD burner, compact disc jukebox), which may be connected to the same device bus or another device bus.

The computer system 102 may be coupled via bus 104 to a display 114 (e.g., cathode ray tube (CRT), liquid crystal display (LCD), LED display, plasma display, voice synthesis hardware, voice synthesis software) for displaying and/or providing information to a computer user. The display 114 may be controlled by a display or graphics card. The display 114 may include one or more interface cards or components (e.g., audio card, video card).

The computer system may include input devices, such as a keyboard 116 and a cursor control 118, for communicating information and command selections to processor 106. Such command selections can be implemented via voice recognition hardware and/or software functioning as the input devices 116. The cursor control 118, for example, is a mouse, a trackball, cursor direction keys, touch screen display, optical character recognition hardware and/or software, etc., for communicating direction information and command selections to processor 106 and for controlling cursor movement on the display 114. In addition, a printer may provide printed listings of the data structures, information, etc., or any other data stored and/or generated by the computer system 102.

The computer system 102 may perform at least a portion or all of the processing steps of an exemplary system for the management of digital multimedia content in response to processor 106 executing one or more sequences of one or more instructions contained in a memory, such as the main memory 108. Such instructions may be read into the main memory 108 from another computer readable medium, such as storage device 112, or may be transmitted by a network connection. One or more processors in a multi-processing arrangement may also be employed to execute the sequences of instructions contained in main memory 108. Alternatively, hard-wired circuitry may be used in place of or in combination with software instructions. Specific combinations of hardware circuitry and software can vary depending on the hardware and software being utilized.

As stated above, the system 102 may include at least one computer readable medium (e.g., compact discs, hard disks, floppy disks, tape, magneto-optical disks, PROMs (EPROM, EEPROM, Flash EPROM), DRAM, SRAM, SDRAM) or memory programmed according to the teachings of an exemplary system for the management of digital multimedia content and for containing data structures, tables, records, or other data described herein. Stored on any one or on a combination of computer readable media, an exemplary system for the management of digital multimedia content may include software for controlling the computer system 102, for driving a device or devices for implementing an exemplary system for the management of digital multimedia content, and for enabling the computer system 102 to interact with a human user. Such software may include, but is not limited to, device drivers, operating systems, development tools, and applications software. Such computer readable media further includes the computer program of an exemplary system for the management of digital multimedia content for performing all or a portion (if processing is distributed) of the processing performed in implementing an exemplary system for the management of digital multimedia content.

The computer code devices of an exemplary system for the management of digital multimedia content may be any interpreted or executable code mechanism, including but not limited to scripts, interpreters, dynamic link libraries, Java classes, and complete executable programs. Moreover, parts of the processing of an exemplary system for the management of digital multimedia content may be distributed for better performance, reliability, and/or cost.

The term “computer readable medium” as used herein refers to any medium that participates in providing instructions to processor 106 for execution. A computer readable medium may take many forms, including but not limited to, non-volatile media, volatile media, and transmission media. Non-volatile media includes, for example, optical, magnetic disks, and magneto-optical disks, such as storage device 112. Volatile media includes dynamic memory, such as main memory 108. Transmission media includes coaxial cables, copper wire and fiber optics, including the wires that comprise bus 104. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM, DVD), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 106 for execution. A Content Manager can be described in the general context of computer executable instructions, such as program modules, or program components, being executed by a computer. Program modules or components include routines, objects, data structures, tasks, etc. that can perform particular tasks or implement particular abstract data types. For example, the Content Manager may be practiced in a distributed computing environment, where the instructions or tasks may initially be carried on a magnetic disk of a remote computer. The remote computer can load the instructions for implementing all or a portion of an exemplary system for the management of digital multimedia content remotely into a dynamic memory and send the instructions over a network connection using, for example, a modem, a network interface card or a wireless connection. In a distributed computing environment, program modules or components can be located in both local and remote computer storage media including memory storage devices.

The computer system 102 also includes a communication interface 120 coupled to bus 104. Communication interface 120 provides a two-way data communication coupling to a network link 122 that may be connected to, for example, a local network 124. For example, communication interface 120 may be a network interface card to attach to any packet switched local area network (LAN), Wireless Local Area Network (WLAN), Wide Area Network (WAN), Metropolitan Area Network (MAN), Small Area Network (SAN), Campus Area Network (CAN), or the like. The network can be in communication with one or more computer systems 102. As another example, communication interface 120 may be an asymmetrical digital subscriber line (ADSL) card, an integrated services digital network (ISDN) card or a modem to provide a data communication connection to a corresponding type of telephone line. Wireless links may also be implemented via the communication interface 120. In any such implementation, communication interface 120 sends and receives electrical, electromagnetic or optical signals that carry digital data streams representing various types of information.

Network link 122 typically provides data communication through one or more networks to other data devices. For example, network link 122 may provide a connection to a computer 126 through local network 124 (e.g., a LAN) or through equipment operated by a service provider, which provides communication services through a communications network 128. Local network 124 and communications network 128 can use electrical, electromagnetic, or optical signals that carry digital data streams. The signals through the various networks and the signals on network link 122 and through communication interface 120, which carry the digital data to and from computer system 102, are exemplary forms of carrier waves transporting the information. The computer system 102 can transmit notifications and receive data, including program code, through the network(s), network link 122 and communication interface 120. Network interfaces include, but are not limited to, Ethernet interfaces, gigabit interfaces, cable interfaces, frame relay interfaces, and DSL interfaces.

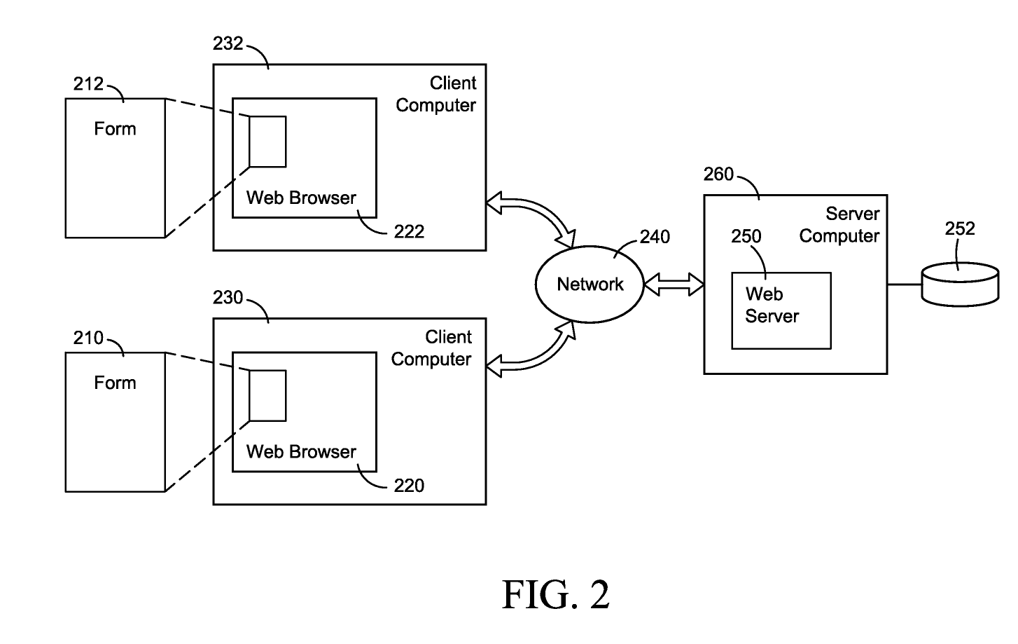

FIG. 2 is a block diagram illustrating first exemplary method in which a first user could use a computer system to accesses an exemplary system for the management of digital multimedia content via a web browser. In FIG. 2, a first user uses a computer system 232 to accesses the Content Manager via a web browser 222.

The user could enter data into a form 212 within said web browser 222. For instance, the user could enter a request for video content into the form 212 in the web browser 222, the request is communicated via the network 240 to a web server program 250 running on the server computer 260, the server computer 260 connecting to at least one database 252 storing digital media content. The protocols that may be used have been discussed herein.

Additionally, a second user could access the Content Manager via a second computer system 230 having a web browser 220 and a form 210. The systems and methods illustrated and described herein may then take place either as a series of steps in a stored program running on the server computer, on another computer or on the web.

The use of “client” and “server” describes the relationship between programs in which one program, the client, makes a service request from another program, the server, which fulfills the request. The client/server relationship can be utilized by programs within a single computer, or in a network. The client or server can include a computer system (e.g., a browser, an application, user, a web page, a computer, a device, a digital media player), that is capable of obtaining information or applications.

One or more databases can be utilized by the Content Manager to store, access, and organize one or more content items, the attributes and metadata associated thereto, and other data (e.g., one or more keys, license information). The one or more content items, the attributes and metadata associated thereto, and other data can be stored in a single database or one or more separate databases. The one or more databases can be executed and/or accessed by the Content Manager using a computer system or processing unit and can comprise one or more of files, folders, forms, documents, and data stored on a computer readable medium and/or media.

An exemplary Content Manager can be used to upload content to a queue that temporarily stores the content, or it can be uploaded to a computer readable medium. Uploading can be done in various ways, including but not limited to, manually triggered by the user, automatically upon connecting a digital client (e.g., USB), automatically upon launch of the Content Manager, automatically performed by a client computer system upon connection to a network, the Content Manager requesting the content (e.g., pulling in a RSS feed, processing an XML file, scraping data from a file, downloading from a database), etc.

Once uploaded, the content can be categorized (tagged) with one or more attributes, where the one or more attributes can be attached to the content as metadata. The content can then be grouped according to the attributes associated thereto. If the content has been uploaded to the queue, the content can then be stored on a computer readable medium. Alternatively, if the content had been stored prior to grouping on a computer readable medium, the content can be updated according to the grouping. The content can be stored in a first location, while information relating to the content can be located in multiple locations (libraries). The content can be shared with third parties using one or more keys, which provide a layer of access to the content displayed on the third parties' Content Manager (where a third party also has a Content Manager). In addition, the content can be shared with third parties using license information. For example, if a third party wishes to access the content, he/she must possess licensing information relating to the content. The content can be linked to a unique ID that can be used to track all modifications to the content or the attributes, licenses, or keys associated thereto. The content can be shared with one or more users (clients) via a server/client connection, or the like. The content can be in a first format and requested in a second format, where the content is converted to the second format prior to sharing the content with the one or more user (clients).

The Content Manager allows for the uploading, storing, editing, managing, and sharing of data, without the need to make derivatives of the data. The Content Manager and one or more content items can be located on a computer, computer readable medium, server, the internet, or the like, and can be maintained or owned by a first user. In an example, when a second user (e.g. client) is interested in reviewing one or more of the content items, a command can be issued to a server computer for access to the content item. If access is granted to the second user (e.g. key, license information), the content can be provided to the second user.

When a user wishes to use the Content Manager, the application is launched either by a desktop version installed on a computer (if the user has a desktop version of the Content Manager), or as a website application, mobile application, which can be launched by a computer, mobile device, or the like. The Content Manager can also be configured to launch, or automatically launch when a digital client such as a disk (computer readable medium) or a removable media object (e.g., USB device, USB thumb drive, CD, DVD, dongle, BLUETOOTH®-enabled device, RFID tag) is connected to the computer or server to allow automatic downloading of the content off of the drive to the computer or server and automatic uploading to the Content Manager. The Content Manager is configurable based on applications of choice. The configuration settings are automatically transferred between interfaces and are stored in secured configuration files.

The Content Manager can comprise multiple accounts for a user or organization. Each account having broad or limited accessibility depending on the type of account. The types of accounts can include, but are not limited to, administrator, content administrator, content manager, content viewer, and library administrator accounts. An administrator account can create accounts, access accounts, delete accounts, amend permissions, and upload, edit, delete, and change metadata associated with content. A content administrator can have all of the abilities of the administrator; however the content administrator cannot access and create accounts. A content manager has the same abilities as a content administrator; however cannot delete content. A content viewer is limited to viewing content. A library administrator can access libraries, share resources, and manage resources.

If accessing the Content Manager as a web application using the internet, a login page of the Content Manager can be associated with a particular URL that is specific to the user/organization. The Content Manager can be provided through a web browser on a user's desktop, mobile device, or other digital clients that have access to the internet (e.g. Wi-Fi, 2G/3G/4G connected GPS interface). A login name and password can be required to access the Content Manager; however, other security measures can be utilized. The Content Manager can be embedded as a client-side application on, for example, a mobile device (e.g., Android®, iPhone®), which can extend into a digital platform. In addition, the Content Manager can be a combination of a website application and a client-side application.

Once a user has successfully logged in, the Content Manager can provide a user interface (UI) to the user. The UI can provide one or more options to the user, as described herein. For example, if the user wishes to locate a particular content item, s/he may click on a keyword provided by the Content Manager or enter a keyword in a search toolbar. When a keyword is selected or entered into the search toolbar, the content in the Content Manager database is filtered to supply only content relevant to the keywords used in the filtering process to the user. Once a first set of filtered results is provided to the user, the Content Manager can provide additional keyword language that can be selected by the user to further filter the content. The additional keyword language provided by the Content Manager is affiliated with or most closely associated with the keyword the user initially selected or input into the search toolbar. The content can be filtered until the user is presented with his/her desired content items.

A user can upload content to the Content Manager by using one or more of a computer, storage device, computer readable medium, the internet, a uniform resource locator (URL), network, user interface, or the like to transfer data from a point of origin to a second location. The second location can be defined by the Content Manager. The Content Manager can be used to manage all files on a computer readable media, where the files could relate to specific formats or file types. The Content Manager can provide a UI to the user allowing the user to upload content to a queue for temporary storage, or store the content on a computer readable medium where the queue can access the content subsequent to storage. One or more files may be uploaded at a time and the progress of the file uploads can be provided to the user (e.g. using a progress bar). The user is provided with the ability to cancel the upload of a content item at any point during the download.

Data can be stored in a variety of forms and in a variety of ways. For example, data can be stored on a computer readable medium, which includes hard disks, floppy disks, removable media objects (e.g., USB device, USB thumb drive, CD, DVD, dongle, BLUETOOTH®-enabled device, RFID tag), tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read. In addition, data can be stored in a variety of formats including, but not limited to, WMA, WAV, AAC, MP3, and MPEG. The user can store data on a storage device (e.g., the user's computer, computer readable medium, on a digital client, on a server, in the cloud).

The Content Manager can provide a queue that can arrange and allow a user or computer to process the content utilizing one or more approaches. For example, the queue could arrange the content by file size, by user preference, or by the order in which the content is uploaded or stored. The arrangement or processing of the content can be in an ascending or descending order. In addition, the Content Manager can provide an activity log allowing the user to view recent activity associated with the Content Manager (e.g., uploading, deleted, editing, storing content).

Once a content item has been uploaded, the Content Manager can provide the user with a notification that the content item is ready to be cataloged (tagged). The Content Manager provides a user with the ability to tag the content with information (attributes). This can be accomplished by the Content Manager launching a UI listing information associated with the content item (e.g., content item's file name, size, date created, date modified) and provide fields for the user to input additional attributes. Alternatively, the attributes may be obtained via the internet, network, or the like, autonomously. The attributes tagged to the content item can relate to one or more keywords, descriptions of the content, title, file number, author, URL, description, notes, rating (e.g., by providing a link/URL to a website describing rating systems), running time, dimensions, images, or the like. The Content Manager can automatically tag a content item based upon existing metadata in the content file (e.g., keywords, file name). The Content Manager may suggest to the user one or more of these attributes, for example by providing a list of popular keywords that may be associated with a particular file type, or to the keywords entered by the user. For example, if the user inputs the keyword “football,” the Content Manager can suggest additional keywords, such as specific player names “Dan Marino,” etc. In addition, the Content Manager may auto-populate one or more of the attributes, for instance automatically “tagging” or “categorizing” a content item based upon a file's existing metadata (e.g., location based data (GPS), keywords, file name).

The Content Manager may also allow the user to associate the content item with a reference image that can be viewed when the content item is listed in a list, search results, or otherwise to the user or a third party. The reference image can be taken from the content item itself (snapshot), uploaded from a file located on a computer readable medium, selected from a gallery, or from the internet (e.g. by providing a URL). Tagging attributes to a content item allows for easily consuming and locating the content by relating it to other content and keywords. This enables easier filtering and searching of the content in large databases. Attributes associated with a content item can be removed, and amended as the user, account owner, or the Content Manager sees fit.

The content item may be tagged (categorized) prior to storage within one or more databases, or subsequent to storage. For example, the Content Manager can provide a user with a list of content items that are untagged. Once an item has been tagged, the Content Manager can remove the item from the list. The list of untagged items can be presented to a user in any order (e.g., chronological order). The untagged content items can be stored on a computer readable medium or temporarily stored in the queue. If attributes are not associated with a particular content item, the Content Manager can require tagging the content item with one or more attributes prior to allowing sharing of the content. For example, the Content Manager may require particular attributes to be associated with the content item prior to being stored, or shared with a client. Tagging the content allows for, among other things, efficiency in usability and shareability of the content (e.g., accuracy in filtering and providing searches for particular content item). For example, the Content Manager can provide a user with the ability to search a database of content items using one or more search terms. Tagging content items allows for a user to quickly find all the content relating to the search terms (e.g., vacation videos, all audio clips about “parenting”). The attributes associated with the content item may be saved as metadata in the content item's file or the attributes may be stored in a separate database and accessed as needed.

Upon uploading the content to the queue or to a computer readable medium, the Content Manager can associate each digital media content item, or a group thereof, with a unique ID. The unique ID allows for tracking all modifications and activities associated with a particular content item. For example, once a modification or activity occurs with respect to a digital media content item, the Content Manager can utilize the unique ID to locate the metadata, attributes, or information associated with the particular content item and amend the data according to the new modified information or activity (e.g. when the content item is amended, edited, the license changes, the keys change, the accessibility changes).

The content may be grouped according to the attributes associated thereto into one or more libraries. For example, a listing of the content may be placed in separate folders or libraries based on the content items name, function, keyword, permission, authentication, attributes, etc. In addition, the metadata, attributes, or other data associated with the content can be stored or viewed in multiple libraries allowing for the content to be reviewed according to the attributes associated thereto, and not based on the location of the file in the queue or computer readable medium. A library can be a list of all content grouped together for a specific use, or having specific attributes. Libraries can be created by the user as necessary or desired and shared with Content Manager's maintained by other users. For example, when a user searches a particular keyword, the Content Manager can provide the user with results that relate to that keyword. The results can include a listing of one or more libraries that contain a content item that relates to that keyword. The one or more libraries provided to the user can include one or more content items that do not relate to the keyword. Each library can contain different groupings of content items, based on each content item's attributes. The grouping of the content items can be based on one or more attributes, user preference, or the Content Manager. If content is associated with one or more libraries, or is associated with one or more shared libraries, the Content Manager may require the content to be removed from the one or more libraries prior to being permanently deleted. The Content Manager can provide for downloading content prior to the content being permanently deleted. Content deleted from the Content Manager can be logged in the activity log. Keywords and attributes that have been associated with a content item that has been deleted will be removed from the Content Manager when the content is deleted.

Each content item, library, and Content Manager account can be associated with one or more keys. A key provides secured accessibility to the content by requiring authentication prior to access. The one or more keys may be provided to a second user (client), allowing that second user to gain access to the content via a network, the internet, or the like. For example, a key may be a license key having a thirty-two digit code that must be provided to the Content Manager by a client prior to receiving access to the content.

A first user (server) can associate particular content, libraries, and attributes with a key. For example, all sports videos can have a single, or multiple keys associated thereto. Alternatively, the second user can provide the first user with a key, wherein the first user can have access to the second user's Content Manager and the content associated thereto. A first user can share one or more libraries with a second user by supplying the Content Manager with the second user's key. This provides the second user with a layer of access to the content shared on his/her account.

The one or more keys can allow access to or sharing of content with a second user (e.g., third party, organization, software application). The one or more keys can be based on one or more licenses, or licensing information, and allow for sharing of content without requiring a duplicate of the content as the content is provided via shared library. License information can comprise information based on one or more of a length of time (e.g., seconds, minutes, hours, days, weeks, months, years, perpetually), a number of content items viewed or played, an Organization ID (identifying an organization able to access the content), a Product ID (identifying a client or “product” able to access the content), and Entry ID (identifying the content itself), and a User ID (identifying the user attempting to gain access to the content). Alternatively, the accessibility to the content may be based on the one or more licenses, or the licensing information, rather than one or more keys. The one or more keys, licenses, licensing information can be stored in one or more databases as a group, or separately.

Examples of licenses include, but are not limited to, shared licenses in which someone has shared the license with you. A shared license may require the user to have an account in the system and may prohibit editing of the files. In addition, a shared license may be withdrawn. Permitted licenses allow the user to read and write on the system. A full permission license allows a user to read, write, delete, edit, and share data on the system. If a second user (client) wishes to access a content item, the second user may be required to supply the Content Manager with information relating to the license, licensing information, or the one or more keys. The information supplied, relating to one or more keys, is compared against the information on the server to confirm the second user's access rights associated with the content item, items, or libraries. If the second user does not have the necessary access rights, access is not provided. License information relating to licenses granted for a particular content item, library, or Content Manager account can be stored in a database, such as a “license database,” locally or otherwise.

The Content Manager provides a user with the ability to retain one copy of a digital media content item and provide various streaming derivatives thereof to one or more second users (e.g., clients). The user can retain a “master” copy of the digital media content item (e.g., on a computer readable storage media) and the Content Manager can use this master copy as needed. The master copy can be uploaded and stored on a computer readable medium as originally formatted, or it may be stored in an alternative base format, as required by the user or the Content Manager. The master copy may be stored on a server computer or a computer readable medium connected to a server computer. The master copy serves as the sole copy of the content item used by the Content Manager to provide the content item to one or more second users.

The Content Manager allows for content to be consumed in different formats depending on user and client factors such as connectivity or the type of digital device (e.g., mobile devices, desktop digital devices, digital media players, home hubs, XBOX®, gaming systems). Instead of creating separate, multiple copies of the content item for different devices or formats, the Content Manager converts (encodes) the master copy into a requested format when a second user (client) requests access to the content item.

Key and/or license information may need to be provided to the Content Manager by the second user prior to accessing the content item. The Content Manager can provide for securing the content through configured administrative trees with permissions, authentication algorithms and product codes. In addition, when providing the content to the client, the Content Manager can utilize hypertext transfer protocol over secure sockets layer (HTTPS), which encrypts the content. For example, a client may request a content item relating to a particular content item (“SportsVideoI”) in a particular format. After the client accesses a Content Manager account, and provides the necessary license and/or key information relating to the content item, the Content Manager accesses the master copy of SportsVideoI, and converts the master copy as it is streamed to the client. Doing so, the Content Manager prevents multiple (derivative) copies of the same content item from being created.

When a client issues a command (request) to the server for access to the content item, the request may obtain data relating to the client (e.g. bandwidth, location, processor size, hardware attributes, software attributes, Authentication Information, Device Information, and Connectivity Information, or the like). Alternatively, or in combination with the client information, the server may request additional information relating to the client, such as Authentication Information, which could include information regarding the one or more keys, licenses, and other authorizations, or the format to stream the content. The Content Manager can allow the content to be shared through an application programming interface (API), or secure API, and allows the client to stream and view the content item in real time.

In another example, the Content Manager can be provided with a unique URL and a path (http) for web requests, thereby allowing individuals on the same network, having the required permissions, to access another user's content.

In another example, a content provider may have a business partner wishing to make use of a content item. Rather than providing the business partner with a copy of the content item, the content provider can provide access to the content via the Content Manager, for instance, thereby allowing the business partner to stream the content. When the relationship with the business partner ends, or the license associated with the content ends, the Content Manager revokes privileges associated with the content item, thereby preventing unauthorized use of the content item.

Prior to providing content to a client, per a request from the client, the Content Manager may require certain information (e.g., Device Information, Connectivity Information). Device Information could include information relating to the client itself (e.g., the form factor of the client, the mode, the specific device the client is utilizing to view the content, the attributes associated with the particular device). For example, the Content Manager can utilize information relating to what type of device the client is (e.g., computer browser, iPad®, mobile phone), whether the device will display the content within an application or within a browser, whether the device's display is in portrait or landscape mode, what type of browser is being used by the client, what display mode is being used, what screen resolution is being used, whether user preferences are provided, what type and quantity of memory is accessible). Connectivity Information could include information regarding the bandwidth available to the client, the type of network being utilized, and the like. Smooth streaming can be implemented to monitor bandwidth and adjust the stream as necessary, thereby optimizing the display of the content item.

For example, if the information indicates that the device is running the Android® operating system with high bandwidth available, the Content Manager might provide the content in a Flash format; if the device is running the Android® operating system with low bandwidth available, the Content Manager might provide the content in a lower resolution format; if the device is an iPad® application, the Content Manager might provide the content in HTML5 format; etc.

In such a configuration, all operational settings are dynamically interchanged between the Content Manager and the client in real time if the digital client is connected to the Internet (via a network). If the client is not connected to the Internet while using the Content Manager, the updated settings and activities can be stored in a local storage (e.g., computer readable medium) and a primary database can be updated upon restoration of the network.

The Content Manager can provide no “auto caching” through web services. In the event of Internet connectivity failure, the Content Manager can stream all the activities in a local computer readable medium and allow the user to upload content, tags, etc., upon connectivity to the primary database. The Content Manager can use web services between the various interfaces, thereby enabling the Content Manager to be always updated across each interface in real time.

Providing the client with a streaming, format-specific version of the content item can be termed as “streaming on the fly.” “Streaming on the fly” conversion has the benefit of allowing a content provider to control access to the content itself, both in the present and in the future, by not providing the client with a copy of the content. The Content Manager can analyze client attributes to determine the best streaming format to provide the content to the client. The Content Manager then obtains the content from a database/storage medium, converts the content to the appropriate format, and streams the content to the client in the appropriate format. The client is then able to display/view the streamed content. Optionally, a streaming cache having a certain lifetime could be provided, to continue to provide the stream to the client in the absence of, or interruption to, an Internet connection. The cache can have an expiration time/date so that any copy of the content held therein is deleted within a certain time frame. Prior to delivering the content, the Content Manager can encode and stream the content, or alternatively, or in combination with encoding and streaming, can compress the digital media content. The encoded and streaming content can be delivered via a network. The use of “streaming” refers to a method of relaying digital media content over a computer network and allowing viewing of the data while, or after, subsequent data is received.

If the master copy of a content item is updated or modified, an Entry ID associated with the file could be updated in the database, allowing a client's content request to be automatically forwarded directly to the new, correct, Entry ID. In addition, if any license is changed, all parties could be notified of the changes so that if someone in the future requests the “old” format (e.g. Entry ID), the system will automatically redirect them to the “new” format. The system could also flag any content that needs to be updated and/or converted to a more current preferred format. For example, the system could flag all legacy file types that need to be converted to a more standard file type.

The first exemplary media content management application (Content Manager) is connected to a database containing digital media content. The database can also include attributes associated to digital media content items, metadata, licensing information, information relating to securing keys, and the like (not illustrated), or this information can be stored in a separate database.

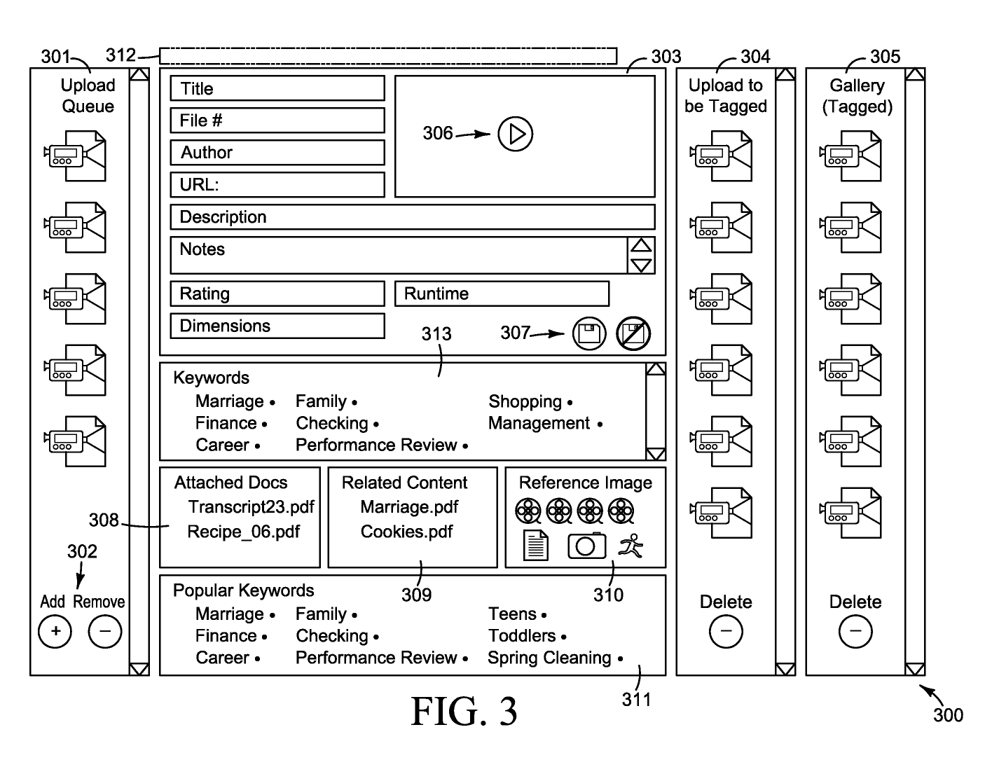

In one exemplary method for the management of digital multimedia content, the Content Manager is accessed via an application. In using the Content Manager, the application would be started. Starting the Content Manager can be accomplished in a variety of ways (e.g., clicking on an icon). Upon initial access, user authentication can be required. User authentication could include providing a username and password to the application. Upon receiving proper authentication information, a user interface can be provided to the user. An example of a Content Manager user interface 300 is provided in FIG. 3 which illustrates an exemplary system for the management of digital multimedia content, illustrating a first exemplary content management interface.

The user interface 300 allows for user interaction with the Content Manager. For example, the user may add or remove content 302 to an upload queue 301, which can temporarily store the content in one or more computer readable mediums or media. Alternatively, the content may be stored to a computer readable medium or database prior to being displayed in the upload queue 301.

The user interface 300 can provide the user with a variety of options relating to content in the queue or stored on a computer readable medium or database. The user interface 300 can provide the user with the ability to view the progress of an upload in progress via a upload status bar 312 and assign attributes 303 to the content and save or cancel the assigned attributes 307. The user interface 300 can provide the user with the ability to view a list of content that needs to be tagged 304 as well as a gallery of content already tagged 305. The user interface 300 can provide the user with the ability to assign keywords 313 to the content and view popular or suggested keywords 311. The user interface 300 can provide the user with the ability to see a list of related content 309. The user interface 300 can provide the user with the ability to attach documents 308, including documents related to the content. The user interface 300 can provide the user with the ability to assign a reference image 310 to the content.

The user interface 300 can provide the user with information relating to sharing the content with one or more second users (e.g., an organization, a friend). The user interface 300 can allow the user to rank, or view rankings, associated with the content. The user interface 300 can provide the user with the ability to search/filter a database of content, or attributes/metadata associated thereto. The user interface 300 can provide the user with the ability to convert the content into one or more formats. The user interface 300 can provide the user with the ability to catalog 303 the content (e.g., provide attributes associated with the content). The user interface 300 can allow a user to view 306 the content. The user interface 300 can allow the user to distribute the content, review distribution rights, and/or amend the distribution rights associated with a content item.

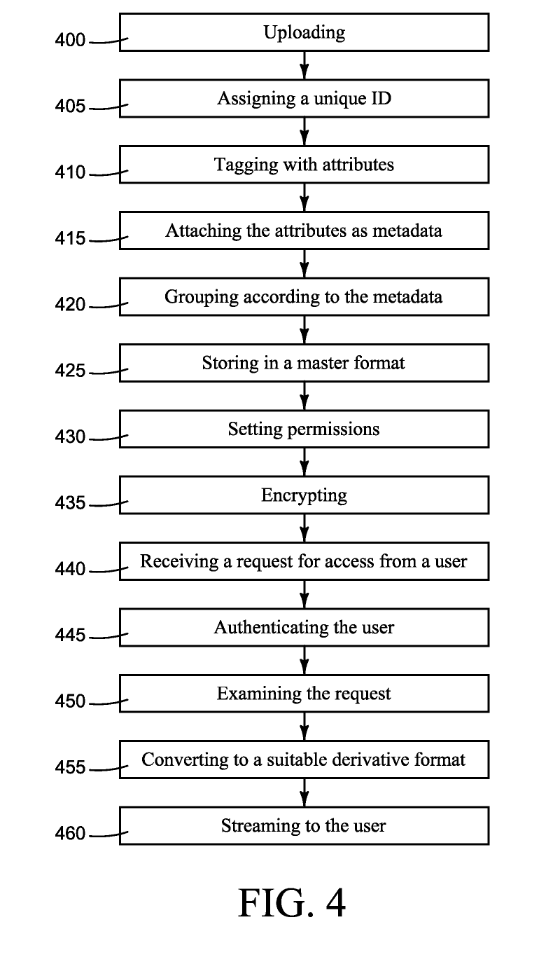

FIG. 4 is a flowchart illustrating a second exemplary method for the management of digital multimedia content. The method starts at 400 where a user uploads digital media content. The Content Manager thereafter assigns the digital media content with a unique ID at 405, the unique ID tracking all modifications of the digital media content and the tagged attributes. The Content Manager then allows a user to tag the digital media content with one or more attributes 410. At 415 the Content Manager attaches the one or more attributes to the digital media content as metadata. At 420 the Content Manager groups the digital media content according to the metadata and stores the digital media content 425. The Content Manager at 430 allows a user to set permissions relating to the content by attaching one or more keys to the digital media content, the one or more keys restricting access to the digital media content. The Content Manager then encrypts the digital media content 435. At 440 the Content Manager receives a request for access to the content from a second user, where prior to sharing the content with the second user, the second user is authenticated 445. The Content Manager can examine the request received by a second user (e.g., format of content, connection speed) 450 and convert the content to a suitable derivative format 455, sharing the digital media content with the second user by streaming the content to the second user 460. The digital media content can be in a first format and be requested in a second format. The digital media content can then be converted to the second format prior to sharing the digital media content with the second user by examining the request which can relate to at least one of connectivity, requested format, and device type of the one or more second users.

In a third exemplary method for the management of digital multimedia content a user can upload digital media content, where the uploaded content can be temporarily stored on a computer readable medium and listed in a queue. The queue can list the content in an order relating to the order of upload. The Content Manager thereafter assigns the digital media content with a unique ID, the unique ID tracking all modifications of the digital media content and the tagged attributes. The Content Manager then allows a user to catalog the content by tagging the content with one or more attributes, the one or more attributes being attached to the digital media content as metadata. The Content Manager groups the digital media content according to the metadata and stores the digital media content. The Content Manager allows a user to set permissions relating to the content by attaching one or more keys to the digital media content, the one or more keys restricting access to the digital media content and being related to security information, and/or license information. The Content Manager then encrypts the digital media content. The Content Manager receives a request for access to the content from a second user, where prior to sharing the content with the second user, the second user is authenticated by providing information relating to the one or more keys. If the second user does not have a key, the user may purchase or license the content and be provided with a key. The Content Manager can examine the request received by a second user and convert the content to a suitable derivative format and share the digital media content with one or more second users by streaming the content to the one or more second users. The Content manager can examine at least one of connectivity, a requested format, and device type of the second user. The digital media content can be in a first format, and the digital media content is requested in a second format, the digital media content being converted to the second format prior to sharing the digital media content with the second user in real-time.

In a fourth exemplary method for the management of digital multimedia content a user can upload digital media content to a computer readable medium. The Content Manager then allows a user to catalog the content by tagging the content with one or more attributes, the one or more attributes being attached to the digital media content as metadata. The Content Manager groups the digital media content according to the metadata and stores the digital media content. The Content Manager receives a request for access to the content from a second user. The Content Manager can examine the request received by a second user and convert the content to a suitable derivative format and share the digital media content with one or more second users by streaming the content to the one or more second users. The Content manager can examine at least one of connectivity, a requested format, and device type of the second user. The digital media content can be in a first format, and the digital media content is requested in a second format, the digital media content being converted to the second format prior to sharing the digital media content with the second user.

In a fifth exemplary method for the management of digital multimedia content a user can upload digital media content into one or more databases. The Content Manager then allows a user to catalog the content by tagging the content with one or more attributes, the one or more attributes being attached to the digital media content as metadata. The Content Manager may require certain attributes to be attached to the content prior to storing the content in a database. The Content Manager groups the digital media content according to the metadata. The Content Manager allows a user to set permissions relating to the content by attaching one or more keys to the digital media content, the one or more keys restricting access to the digital media content and being related to security information, and/or license information. The Content Manager then encrypts the digital media content. The Content Manager receives a request for access to the content from a second user, where prior to sharing the content with the second user, the second user is authenticated by providing information relating to the one or more keys. If the second user does not have a key, the user may purchase or license the content and be provided with a key. The Content Manager can examine the request received by a second user and convert the content to a suitable derivative format and share the digital media content with one or more second users by streaming the content to the one or more second users. The Content manager can examine at least one of connectivity, a requested format, and device type of the second user. The digital media content can be in a first format, and the digital media content is requested in a second format, the digital media content being converted to the second format prior to sharing the digital media content with the second user.

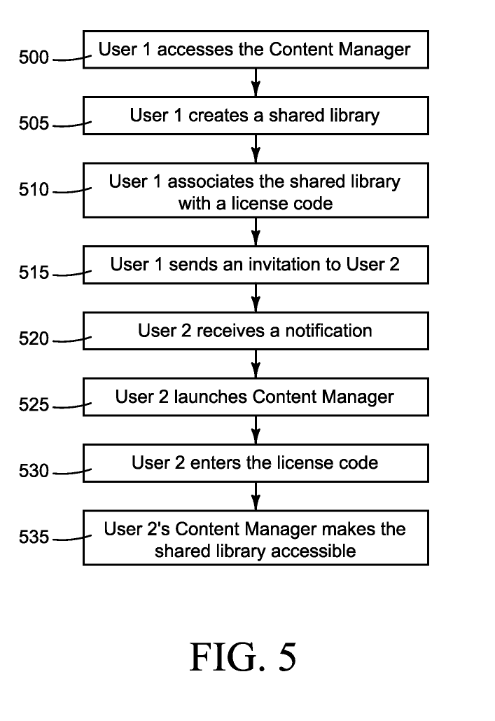

FIG. 5 is a flowchart illustrating a sixth exemplary method for the management of digital multimedia content. At 500 User 1 accesses the Content Manager to share content with user 2. At 505 User 1 creates a shared library within his/her Content Manager. At 510 User 1 associates the shared library with a generated license code. Subsequent to generating a license code for the shared library, user 1 send an invitation 515 to user 2 to share the library with user 2. User 2 receives a notification 520 relating to the invitation 515 to access the shared library. User 2 launches his/her Content Manager 525 and enters the license code generated by user 1 530. Once the license code is entered, user 2's Content Manager makes the shared library accessible to user 2 to consume 535.

In a seventh exemplary method for the management of digital multimedia content, the Content Manager is utilized to manage all files on a computer (as a Finder (Mac) or Windows Explorer replacement).

While, for purposes of simplicity of explanation, the one or more methodologies shown and described herein, for example, in the form a flow chart, is shown and described as a series of acts, it is to be understood and appreciated that the Content Manager is not limited by the order of acts, as some acts can occur in a different order, concurrently with other acts, or concurrently with other acts than those shown and described. For example, those skilled in the art will understand and appreciate that a methodology could alternatively be represented as a series of interrelated states or events.

The Content Manager may also provide the user with a video graphic manipulation interface that allows the user to associate the content item with reference frames and icons, in addition to resizing and reformatting the content item. The content item is placed in one or more libraries based upon the attributes associated thereto.

The Content Manager may also provide enhanced searching abilities, giving the user the ability to search beyond just categories, keywords, tags and the like. For instance, the Content Manager may utilize natural language searching with the ability to suggest content. The Content Manager could also implement semantic searching, could utilize searching using a Lucene search engine, could automatically examine and index certain files (e.g., text, PDFs), could utilize optical character recognition (OCR) files, could utilize facial recognition in photos, could utilize text recognition in photos, and could include advertisements.

The Content Manager could include an ecommerce component that allows one or more second users to purchase or license digital media content. In example, a third party viewing the publicly accessible part of an owner's content in his/her Content Manager could decide that s/he would like to purchase the right to utilize a particular content item (e.g., photograph, video). The Content Manager would have the functionality for allowing the purchase/license. A watermark could be added automatically to the content. The content item could be provided with one or more time limits (expiration dates).

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. A computer-implemented digital media content management system comprising the following computer executable components:
an upload component that uploads digital media content;
a queue component that temporarily stores the digital media content;
a catalog component that allows a first user to tag the digital media content with one or more attributes;
a storage component that stores the digital media content;
a grouping component that groups the digital media content according to the one or more attributes;
a licensing component that attaches one or more keys to the digital media content;
a security component that encrypts the digital media content; and
a sharing component that allows one or more second users to access the digital media content.

2. The system of claim 1, the one or more attributes being attached to the digital media content as metadata.

3. The system of claim 1, the queue component temporarily storing the digital media content in an order relating to at least one of by order of upload to the upload component, by file size, and by user preference.

4. The system of claim 1, the one or more attributes relating to at least one or more of a title, item number, file number, owner, author, URL, notes, description, rating, running time, dimensions, feed, keyword, reference images, and transcripts of the digital media content.

5. The system of claim 1, the storage component storing the digital media content on at least one of a computer, digital client, server, and the cloud and being accessible by the first user.

6. The system of claim 1, where the one or more keys restrict access to the digital media content.

7. The system of claim 6, the sharing component requiring the one or more second users to provide information relating to the one or more keys prior to allowing access to the digital media content.

8. The system of claim 7, where the sharing component streams the digital media content to the one or more second users.

9. The system of claim 1, further comprising a converting component that converts the digital media content from a first format to a second format.

10. The system of claim 9, where the converting component converts the digital media content according to at least one of connectivity, requested format, and device type of the one or more second users.

11. The system of claim 10, where the requested format can be provided by at least one of the one or more second users, a browser, an application, a web page, a computer, a device, and a digital media player.

12. The system of claim 1, where the digital media content is assigned a unique ID upon being uploaded by the upload component.

13. The system of claim 1, further comprising an ecommerce component that allows one or more second users to purchase or license digital media content.

14. The system of claim 13, where the unique ID tracks all modifications of the digital media content and the tagged attributes.

15. A computer-implemented method of managing digital multimedia content comprising the following computer-executable acts:
uploading digital media content to a queue that temporarily stores the digital media content;
tagging the digital media content with one or more attributes, the one or more attributes being attached to the digital media content as metadata;
grouping the digital media content according to the metadata;
storing the digital media content;
attaching one or more keys to the digital media content; and
sharing the digital media content with one or more second users,
where the digital media content is in a first format, and the digital media content is requested in a second format, the digital media content being converted to the second format prior to sharing the digital media content with the one or more second users.

16. The method of claim 15, where the request for the digital media content in the second format is provided by at least one of the one or more second users, a computer, a browser, an application, a web page, a device, and a digital media player.

17. The method of claim 15, where the request for the digital media content in the second format includes information relating to a desired size, encoding, resolution, bandwidth, browser type, type of user, and license information.

18. The method of claim 15, where the digital media content and tagged attributes are stored on at least one of a digital client, computer, the cloud, or a server.

19. The method of claim 18, where digital media content and tagged attributes are dynamically updated in real-time between a first user's application and a web-application via web connectivity.

20. The method of claim 19, where the first user's application stores the digital media content and tagged attributes on a local computer-readable medium upon failure of web connectivity to the web-application and updates the web-application upon restoration of web connectivity.

21. A computer-implemented method of managing digital multimedia content comprising the following computer-executable acts:
uploading digital media content, the digital media content being assigned a unique ID, the unique ID tracking all modifications of the digital media content and the tagged attributes;
tagging the digital media content with one or more attributes, the one or more attributes being attached to the digital media content as metadata;
grouping the digital media content according to the metadata;
storing the digital media content;
attaching one or more keys to the digital media content, the one or more keys restricting access to the digital media content;
encrypting the digital media content; and
sharing the digital media content with one or more second users,
where the digital media content is in a first format, and the digital media content is requested in a second format, the digital media content being converted to the second format prior to sharing the digital media content with the one or more second users, the second format relating to at least one of connectivity, requested format, and device type of the one or more second users,
where the one or more second users are required to provide information relating to the one or more keys prior to sharing the digital media content,
where the digital media content is streamed to the one or more second users.
